(19) United States
(12) Patent Application Publication
(10) Pub. No.: US 2009/0140856 A1
(43) Pub. Date: Jun. 4, 2009

(54) SAFETY SYSTEM AND METHOD

(75) Inventors: Cameron Anthony George, Victoria (AU); Adrian Pennisi, Queensland (AU); Heinrich Herman Gustav Nellen, Queensland (AU); Scot Farley, Queensland (AU); Thorsten Nellen, New South Wales (AU); Simon Robert Amon, Gauteng (ZA); Jeremiah Emanuel Josey, Queensland (AU)

Correspondence Address: BROOKS KUSHMAN P.C., 1000 TOWN CENTER, TWENTY-SECOND FLOOR, SOUTHFIELD, MI, 48075, US

(73) Assignee: POZILOK HOLDINGS PTY LTD, Tarragindi, QLD (AU)

(21) Appl. No.: 11/570,003

(22) PCT Filed: Jun. 3, 2005
(86) PCT No.: PCT/AU2005/000800

§ 371 Date: Dec. 5, 2007

(30) Foreign Application Priority Data
Jun. 4, 2004 (AU) 2004902994

(51) Int. Cl. E05B 45/06

(52) U.S. Cl. 340/542

(57) ABSTRACT

The safety system comprises an electro-mechanical locking device (110) moveable between an unlocked position and a locked position. When the electro-mechanical locking device is in the locked position and is located on an energy isolation element (120) of a plant, energy is isolated at the isolation element. A mobile unit (130) is adapted to communicate with the electro-mechanical locking device in order to move the electro-mechanical locking device between the locked and unlocked position. When the electro-mechanical locking device is moved to the locked position a confirmation signal (260) is communicated to the mobile unit confirming that the electro-mechanical locking device is locked.

### FIELD OF THE INVENTION

The invention relates to a safety system and method for use in industrial applications. In particular, although not exclusively, the invention relates to a system and method to safely isolate equipment for maintenance and repair purposes.

### BACKGROUND TO THE INVENTION

Increasing regulations and safety awareness within heavy industry are forcing operating companies to seek more robust and secure processes and procedures for isolating equipment for maintenance and upgrade purposes.

Each year, many operators are injured or killed by the hazardous uncontrolled release of energy whilst performing maintenance or upgrade of machinery. Many industries use lockout procedures in an attempt to minimise the risks to employees whilst working in hazardous situations on or around this machinery. A lockout process is used by many industries to prevent machinery being energised during equipment maintenance or repair. In this context, energy may be electrical, hydraulic, compressed air or the like.

Generally, lockout involves a lock being attached to an energy isolation device when the device is in the off position. For example, an electrical power lever may be located in the off position and locked there by a simple padlock that physically prevents the handle from being turned to the on position and hence isolates the electrical power from the machine. Additionally, an operator may also locate a tag over the padlock to indicate who has locked out the machinery.

However, there exists many problems with this lockout system. For example, operators are prone to leave a work site without having removed their padlock from the machines isolation element. Obviously, a padlock cannot be broken and the machine started without ascertaining the whereabouts of the operator. This results in prolonged periods of downtime for the machine and hence consequent production losses.

Furthermore, when maintenance is being carried out on larger machines wherein a number of operators are required, the prior art lockout systems are inefficient and archaic and subject to human error. In short, the prior art systems do not scale well to larger applications.

Additionally, there does not exist a method of reliably auditing the lockout systems of a workplace in order to provide evidence that best practice safety systems are being met in accordance with legislation.

As such, it is desirable to alleviate the problems associated with equipment lockout in order that a auditable, scaleable and safer lockout system is available.

### OBJECT OF THE INVENTION

It is an object of the invention to overcome or at least alleviate one or more of the above problems and/or provide the consumer with a useful or commercial choice.

### DISCLOSURE OF THE INVENTION

In one form, although it need not be the only or indeed the broadest form, the invention resides in a lockout method for locking out at least one isolation element of a plant, said method including the steps of:

(i) communicating a locking signal from a mobile unit to an electro-mechanical locking device whilst said electro-mechanical locking device is in an unlocked position, said locking signal including a unique operator identifier whereby said electromechanical locking device is moved to a locked position in response to said locking signal;

(ii) storing said unique operator identifier in said electro-mechanical locking device; and

(iii) communicating a confirmation signal from said electro-mechanical locking device to said mobile unit, said confirmation signal confirming said electro-mechanical locking device is in said locked position;

wherein, said electro-mechanical locking device isolates energy at said isolation element when said electro-mechanical locking device is in said locked position.

In a further form, the invention resides in a lockout method for locking out at least one isolation element of a plant, said method including the steps of:

(i) communicating a unique isolation element identifier from an isolation element identification device to a mobile unit, said isolation element identification device identifying said isolation element;

(ii) storing said unique isolation element identifier in said mobile unit;

(iii) communicating a locking signal from a mobile unit to an electro-mechanical locking device whilst said electro-mechanical device is in an unlocked position, said locking signal including a unique operator identifier whereby said electro-mechanical locking device is moved to a locked position isolating energy at said isolation element in response to said locking signal;

(iv) storing said unique operator identifier in said electro-mechanical locking device;

(v) communicating a confirmation signal from said electro-mechanical locking device to said mobile unit, said confirmation signal confirming said electro-mechanical locking device is in said locked position;

(vi) storing said confirmation signal in said mobile unit;

(vii) detecting, at said isolation element identification device, that energy has been isolated at said isolation element; and, if so;

(viii) communicating a confirmation signal from said isolation element identification device to said mobile unit; and

(ix) storing said confirmation signal in said mobile unit.

In a further form, the invention resides in an electromechanical locking device for locking out at least one isolation point of a plant, said device comprising:

a processing and data storage module;

a data port in communication with said processing and data storage module; and

a lock moveable between a locked position and an unlocked position under control from said processing and data storage module and in response to a locking signal received at said data port;

whereby, said processing and data storage module communicates a confirmation signal to said data port data and processing module detects when said lock has been moved to said locked position.

In still a further form, the invention resides in a mobile unit adapted for communication with a electro-mechanical locking device for locking out at least one isolation point of a plant, said device comprising:

a processing and data storage module, said processing and data storage module having a unique operator identifier stored therein; and

a data port in communication with said processing and data storage module;

wherein, said mobile unit is adapted to communicate a locking signal to said electro-mechanical locking device to move said electro-mechanical locking device to a locked position, said locking signal including said unique operator identifier, said mobile unit further adapted to receive a confirmation signal from said electro-mechanical locking device confirming said electro-mechanical locking device is in said locked position.

In still a further form, the invention resides in a lockout system for isolating at least one isolation element of a plant, said system comprising:

an electro-mechanical locking device moveable between an unlocked position and a locked position, said locked position isolating energy at said isolation element; and

a mobile unit adapted to communicate with said electro-mechanical locking device to move said locking device between said locked position and said unlocked position;

wherein, said electro-mechanical locking device moves to said locked position in response to a locking signal being communicated from said mobile unit to said electro-mechanical locking device, said electro-mechanical locking device communicating a confirmation signal to said mobile unit confirming said electro-mechanical locking device is in said locked position.

In still a further form, the invention resides in a system for locking out at least one isolation element of a plant, said system comprising:

an electro-mechanical locking device according to the present invention; and

a mobile unit according to the present invention;

wherein said mobile unit is adapted to communicate with said electro-mechanical locking device to perform the method of the present invention.

Further features of the present invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a schematic of a lockout system according to an embodiment of the present invention;

FIG. 2 shows a lockout method according to an embodiment of the present invention;

FIG. 3 shows a method of removing a lockout according to an embodiment of the present invention;

FIG. 4 shows a schematic of a further embodiment of the lockout system shown in FIG. 1;

FIG. 5a shows a further embodiment of the lockout method shown in FIG. 2;

FIG. 5b continues the lockout method shown in FIG. 5a; and

FIG. 6 shows a further embodiment of the lockout method of the present invention.

### DETAILED DESCRIPTION OF THE INVENTION

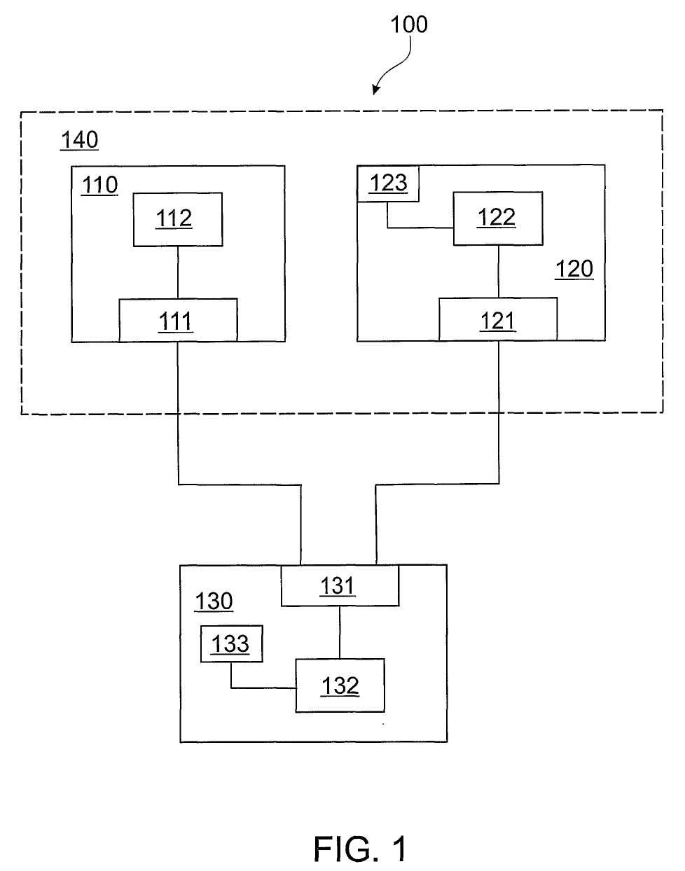

FIG. 1 shows a schematic of a lockout system 100 according to an embodiment of the present invention. Safety system 100 is used to facilitate an improved lockout procedure for industrial plants whereby isolation of energy to equipment is necessary to prevent the motive power of the machine in order to conduct maintenance and repair work. In this context, plants refer to mine sites, refineries, electrical power stations, chemical processing plants and the like. Safety system 100 comprises an electro-mechanical locking device 110, an isolation element identification device 120 and a mobile unit 130.

Electro-mechanical locking device 110 and isolation element identification device 120 are located on an equipment isolation element 140. Hence, in this embodiment each isolation element 140 has a dedicated electro-mechanical locking device 110 and isolation element identification device 120. Equipment isolation element 140 may be a valve, an electrical switch, a motor control center for plant equipment or indeed any isolation element whereby hazardous energy is isolated from a machine. Mobile unit 130 remains with a maintenance operator. It will be appreciated that each maintenance operator has a mobile unit 130.

Optionally, each isolation element 140 has a plurality of locking devices 110 associated with isolation element identification device 120. Hence, each locking device 110 associated with the isolation element identification device 120 locks out a part of the isolation element 140.

In its simplest form, electro-mechanical locking device 110 is a padlock that has a data port 111 and a processing and data storage module 112 in communication with the data port 111. The padlock is movable between a locked position an unlocked position by means of an electrical locking signal communicated to the data port 111. This locking signal is communicated to the processing and data storage module 112 which then energizes a solenoid that controls a shackle of the padlock. Optionally, the electro-mechanical locking device 110 may have stored in the processing and data storage module 112 a unique lock identifier.

Isolation element identification device 120 is located at isolation element 140 and comprises a data port 121 and a processing and data storage module 122 in communication with data port 121. Processing and data storage module 122 has stored therein a unique isolation identifier for the isolation element 140 upon which it is mounted.

Optionally, isolation element identification device 120 further comprises an isolation module 123. Preferably, isolation module 123 is a sensor able to detect the status of an isolation lever of the isolation element 140. For example, isolation module 123 is able to detect when a lever of the isolation element 140 has been moved to a position that isolates energy from the isolation element 140. Optionally, isolation module 123 is able to electrically isolate the power to the machinery which equipment isolation element 140 controls.

Mobile unit 130 comprises a data port 131 and a processing and data storage module 132 in communication with data port 131. As previously discussed each mobile unit 130 is allocated to an operator. As such, each mobile unit 130 has a unique identifier stored therein that is associated with the operator whom the mobile unit 130 is allocated. The operator's unique identifier is stored within processing and data storage module 132.

Additionally, mobile unit 130 comprises a power source 133 for the provision of power to mobile unit 130. Power source 133 may be in the form of a lithium battery or the like.

Each operator may retain the mobile unit 130 permanently during their employment with the mine or plant or the like. Optionally, each operator may be issued a mobile unit 130 at the commencement of a shift with the operator's unique identifier being stored in processing and data storage module 132 at this time.

Preferably, electro-mechanical locking device 110, isolation element identification device 120 and mobile unit 130 are intrinsically shielded for applications where electrical/magnetic field leakage may result in the combustion of volatile material.

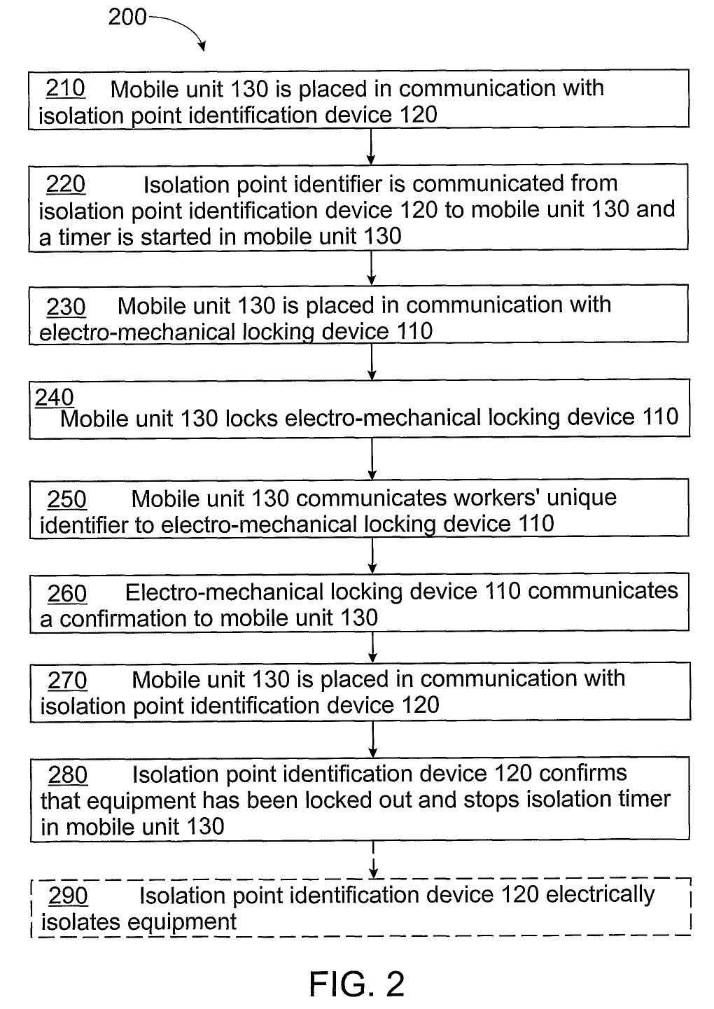

FIG. 2 shows a method 200 for locking out a machine according to an aspect of the present invention. Safety system 100 provides the infrastructure upon which safety method 200 is implemented. As previously discussed, an operator has in their possession a mobile unit 130 having that operator's unique identifier stored in processing and data storage module 132. The operator may retain this mobile unit 130 throughout their employment with the mine, plant or the like and hence have their unique identifier permanently stored in processing and data storage module 132. Optionally, an operator may be issued with a mobile unit 130 upon commencement of a shift and hence have their unique identifier stored in processing and data storage module 132 at this time.

Method 200 commences when it is desirable to isolate energy at isolation element 140 from equipment for maintenance, repair or similar such work. Mobile unit 130 is placed in communication with isolation element identification device 120 (Step 210). Preferably, this is achieved by placing data port 131 of mobile unit 130 in contact with data port 121 of isolation element identification device 120.

The isolation element identification device 120 communicates the unique isolation identifier for the isolation element 140 upon which it is mounted to mobile unit 130 (Step 220). The isolation identifier is stored in the processing and data storage module 132 of the mobile unit 130. Additionally, an isolation timer is started in mobile unit 130.

Mobile unit 130 is then placed in communication with electro-mechanical locking device 110 (Step 230). Hence, data port 131 of mobile unit 130 is placed in communication with data port 111 of electro-mechanical locking device 110.

The operator then indicates on the mobile unit 130 that the electro-mechanical locking device 110 should be moved to the unlocked position. Preferably, this is facilitated by means of the operator pressing an unlock button on the mobile unit 130. This signal is communicated to the processing and storage module 112 of electro-mechanical locking device 110. A shackle of the electro-mechanical locking device 110 is forced to the unlock position by means of a solenoid under control of the processing and storage module 112. A locking timer is then started in mobile unit 130.

Suitably, mobile unit 130 has stored therein one or more a unique lock identifiers that mobile unit 130 is able to interact with. If the unique lock identifier of the electro-mechanical locking device 110 does not correspond with the set stored in mobile unit 130, a successful locking signal will not be generated for this electro-mechanical locking device.

The electro-mechanical locking device 110 is then placed over, for example, a valve lever of the machine that is to be isolated when this lever is in the off position (i.e. when the electrical power, for example, has been isolated from the machine). The mobile unit 130 is then placed into communication with the electro-mechanical locking device 110 as before and the operator moves the shackle to the locked position by, for example, pressing a lock button on the mobile unit 130 which communicates a locking signal from the mobile unit 130 to the electro-mechanical locking device 110 (Step 240). Additionally, the operators unique identifier is communicated to electro-mechanical locking device 110 by mobile unit 130. Optionally, the unique isolation element identifier is also communicated to the electro-mechanical locking device 110 by mobile unit 130. This information is stored in processing and data storage module 112 (Step 250).

The electro-mechanical locking device 110 then detects that the electro-mechanical locking device is moved to the locked position and communicates a confirmation signal to the mobile unit 130 that it is in the locked position (Step 260). Suitably, the processing and data storage module 112 of the electro-mechanical locking device 110 detects that a shackle of the electro-mechanical locking 110 is in a position that corresponds to a locked position for the electro-mechanical locking device 110.

The confirmation signal received from the electro-mechanical locking device 110 is stored in the processing and data storage module 132 of the mobile unit 130. Additionally, the locking timer in the mobile unit 130 is stopped.

If the mobile unit 130 does not receive the locking confirmation signal from the electromechanical locking device 110 that it has been locked, an alarm is raised by the mobile unit 130 to indicate to the operator that the electro-mechanical locking device 110 has not been locked. Furthermore, if this locking confirmation is not received within a predetermined period of time the locking timer in mobile unit 130 expires and an alarm is sounded.

The mobile unit 130 is then placed in communication with the isolation element identification device 120 as described previously (Step 270). The mobile unit 130 communicates to the isolation element identification device 120 the locking confirmation signal received from the electromechanical locking device 110 indicating that the electro-mechanical locking device 110 has been locked (Step 280).

Additionally, isolation module 123 senses that a lever or valve of the isolation element 140 has been moved to the locked position isolating energy from isolation element 140. Confirmation of this isolation is communicated to mobile unit 130 and thus isolation timer in mobile unit 130 is stopped.

Additionally, the mobile unit 130 communicates the unique identifier of the operator the isolation element identification device 120. This identifier is stored in the processing and data storage module 122 of the isolation element identification device 120.

If the mobile unit 130 does not receive communication from the isolation element identification device 120 that the isolation element has been isolated, the isolation timer in the processing and data storage module 132 of the mobile unit expires and an alarm is triggered at mobile unit 130. The alarm continues until the confirmation signal from the isolation element identification device 120 confirming the isolation element 140 has been isolated is received by mobile unit 130.

Optionally, the operator may then place a visual indication over the electro-mechanical locking device 110 in order that other operators are aware that the machine is currently isolated at the isolation element 140. This visual indication may be in the form of a tag as is known in the art.

The above system provides an operator with a confirmation indicating that a machine is completely isolated at its isolation element prior to the commencement of any work. This ensures that all energy is isolated from a machine and thus delivers a higher level of safety to operators than prior art lockout systems.

As previously discussed, optionally isolation module 123 of isolation element identification device 120 physically isolates the energy from the machine (Step 290). Hence, in the case where isolation element 140 isolates electrical energy, then isolation module 123 is in the form of an electrical circuit that opens ensuring that no flow of electricity to the machine is possible.

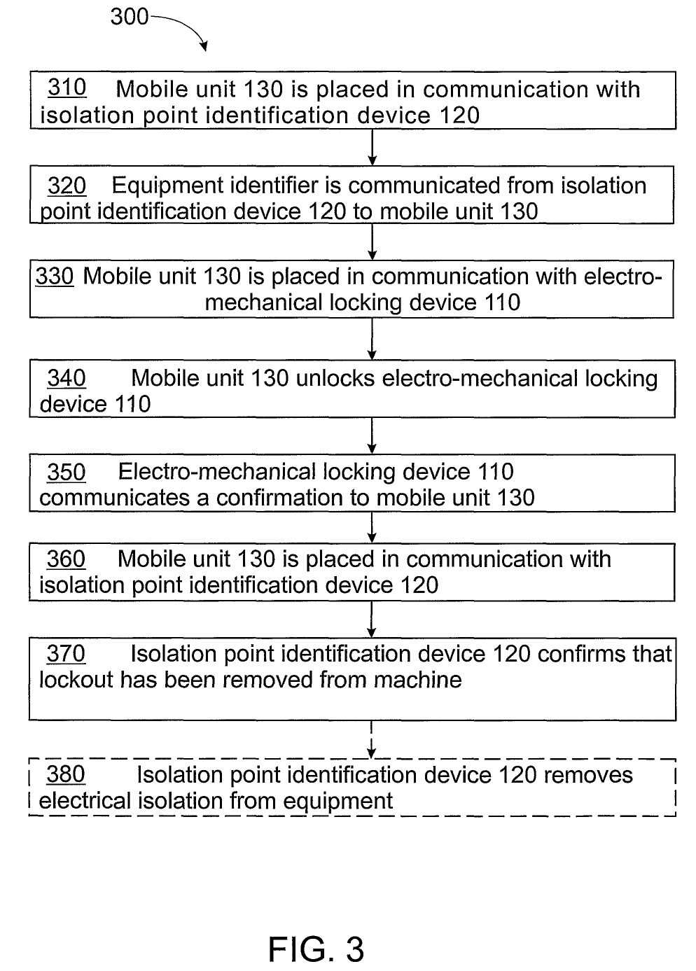

When the operator has finished the work on the machine the energy source must be reconnected. FIG. 3 shows a method 300 of reconnecting the energy source to the machine at isolation element 140

The mobile unit 130 is placed in communication with the isolation element identification device 120 (Step 310). The unique isolation identifier is communicated from the isolation element identification device 120 to the mobile unit 130 (Step 320). The mobile unit 130 is then placed in communication with the electro-mechanical locking device 110 (Step 330) and communicates the operators unique identifier along with the isolation identifier to the electro-mechanical locking device 110.

The electromechanical locking device 110 then verifies that the operator's unique identifier corresponds with the unique identifier of the operator that initiated the lockout procedure (i.e. as in step 250). Upon positive confirmation, the electromechanical locking device then unlocks itself from the lever or the like upon which it was placed and communicates confirmation of this unlocking to mobile unit 130 (Step 350).

If the operators unique identifier communicated by the mobile unit 130 to the electro-mechanical locking device 110 does not correspond with the unique identifier of the operator that locked the electro-mechanical locking device, as stored in processing and data storage module 112, then the electro-mechanical locking device 110 will not unlock.

The mobile unit 130 is then placed in communication with the isolation element identification device 120 (Step 370) and the isolation module 123 of the isolation element identification device 120 confirms that a lever of the isolation module 140 is moved to an open position, indicating that isolation element 140 no longer isolates energy from the respective equipment. Confirmation of this is then communicated to mobile unit 130 and this is saved in mobile unit 130.

If the isolation element identification device 120 has electrically isolated the machine (as in Step 290) then the processing and data storage module 132 then proceeds to instruct isolation module 123 to remove the electrical isolation from the machine.

Hence, the isolation element 140 is now no longer isolates the energy source from the machine and the machine may be re-energized.

Optionally, in situations where there are multiple operators undertaking maintenance on a single machine, it is necessary to ensure that all operators perform the lockout process when commencing work and to remove the lockout process before the machinery is re-energized. It is important to ensure that all operators have finished work before the machine is re-energized.

In applications where this is necessary the electromechanical locking device 110 stores in processing and data storage module 112 the unique identifier of all operators who have carried out the lockout procedure as shown in FIG. 2. As described, the unique operator identifier of each further operator is communicated from the one or more further mobile units 130 of each operator to the electro-mechanical locking device 110. Preferably, the isolation element identification device 120 also retains in processing and data storage module 122 the unique identifier of all operators who have carried out the lockout procedure as in FIG. 2.

As each operator completes their specific task on the machine and proceeds to carry out the method of reconnecting the machine to the energy source as in FIG. 3, the electromechanical locking device 110 removes that operators unique identifier from its processing and data storage module 112 in response to an unlocking signal from each one or more further mobile units 130 associated with the maintenance staff. However, when the last operator undertakes the procedure shown in FIG. 3 will the electro-mechanical lock 110 will proceed to unlock itself from the lever or the like in order the energy can be reconnected to the machine. This ensures that all operators are no longer conducting work on the machinery and hence the energy may be safely reconnected without the risk of injuring an operator who is still located on the machine.

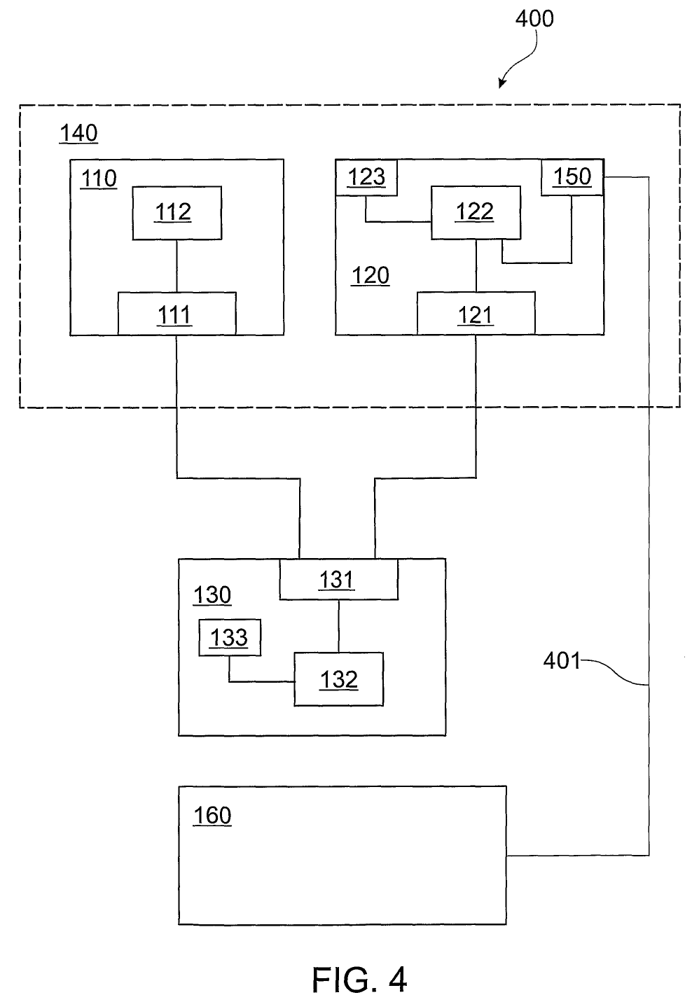

FIG. 4 shows a schematic of a safety system 400 according to a further embodiment of the present invention. Safety system 400 differs from safety system 200 in that it further comprises a communication module 150 and a management module 160 in communication with communication module 150.

Preferably, communication module 150 forms part of isolation element identification device 120 and is in communication with processing and data storage module 122. Optionally, communication module 150 is located separately from isolation element identification device 120.

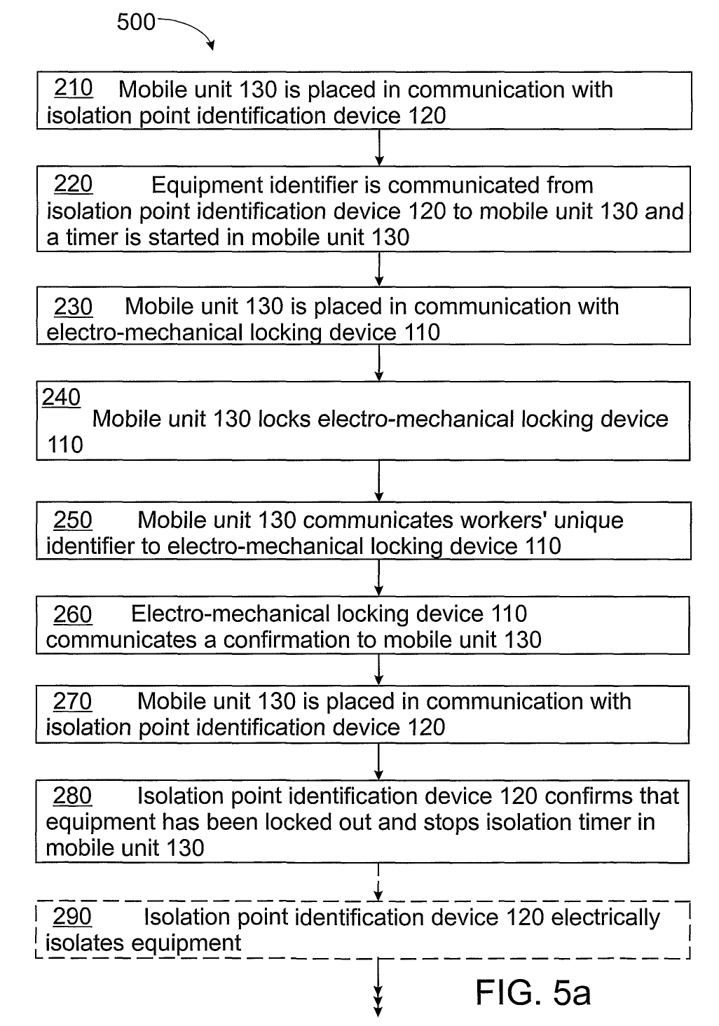

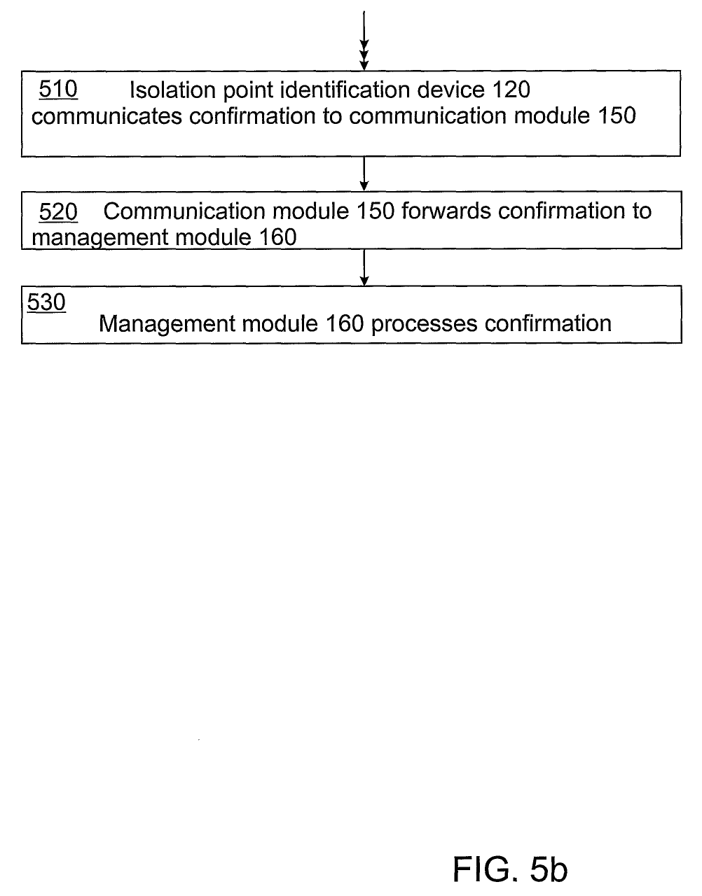

Communication module 150 then forwards this information to management module 160 as shown in FIGS. 5a and 5b.

FIGS. 5a and 5b shows a safety method 500 according to a further embodiment of the present invention. As shown, safety method 500 has additional steps when compared to safety method 200 shown in FIG. 2.

When an operator has successfully isolated an energy source from a machine, the processing and data storage module 122 of isolation element identification device 120 generates a confirmation signal and communicates this confirmation signal to communication module 150 (Step 510). This confirmation signal indicates that isolation element 140 has been successfully locked out and preferably includes the unique identifier of the operator, the unique identifier of the isolation element and the time and date at which the lockout occurred. Optionally, the confirmation signal may further include the unique electro-mechanical locking device identifier.

This confirmation signal is then communicated from communication module 150 to management module 160 via communication pathway 401 (Step 520). Preferably, communication pathway 401 forms part of the local area network of the plant or the like. It will be appreciated that communication pathway 401 may take the form of any communication pathway known in the art such as a wireless communication pathway or the like. As such, it will be appreciated that both communication module 150 and management module 160 are configured to communicate via pathway 401.

Management module 160 then processes this data (Step 530). Management module 160 is a software program configured to interact with and manage lock out processes in industrial workplaces. In particular, management module 160 collects data from a plurality of communication modules 150 located around the work place in order that there is a central repository of real time data showing what isolation elements are currently locked out. Hence, the lockout information from the whole work site is logged, stored and viewable from a single access.

Additionally, when a lockout is removed at an isolation element 140 this information is communicated to management module 160 in the same manner.

This facilitates an auditable lock-out system such that legislative guidelines may be shown to be met with historical lockout data easily accessible. Furthermore, it provides a lockout system that has a higher safety threshold as all lockout procedures may be monitored from a central location and confirmation that a machine has been isolated is easily obtainable.

Optionally, communication module 150 may be located separately from isolation element identification device 120. In this embodiment, the confirmation signal generated by isolation element identification device 120 is communicated to mobile unit 130. Processing and data storage module 132 of mobile unit 130 then stores this confirmation signal. It will be appreciated that each mobile unit 130 is able to store a plurality of confirmation signals.

Alternatively, the mobile unit 130 may be in direct communication with the management module 160 by means of a wireless communication network.

The operator places the mobile unit 130 in communication with communication module 150 directly and transmits all confirmation signals stored in processing and data storage module 132 to communication module 150. The designated communication module 150 then forwards this data to management module 160 via communication pathway 401 as previously described.

Safety system 400 ensures that no operator may leave the workplace without having removed a lockout from an isolation element. As described previously, this can result in significant down time. At the end of a shift all operators place their mobile unit 130 in communication with a designated communication module 150. Communication module 150 then sends a request to management module 160 indicating that the operator is intending to leave the work place.

Management module 160 then inspects records stored therein to determine if the communicated unique identifier for that operator has locked out any isolation elements 140 without removing the lockout. If the records of the management module 160 indicate that a lockout is still pending for that operator the management module 160 transmits an alert to the designated communication module 150 and an indication is given to the operator that there is an isolation element 140 that they have omitted to remove the lock out from.

In a further application, communication module 150 allows two way communication between each mobile unit 130 and management module 160 in order that lock out procedures may be authorized from the management module 160.

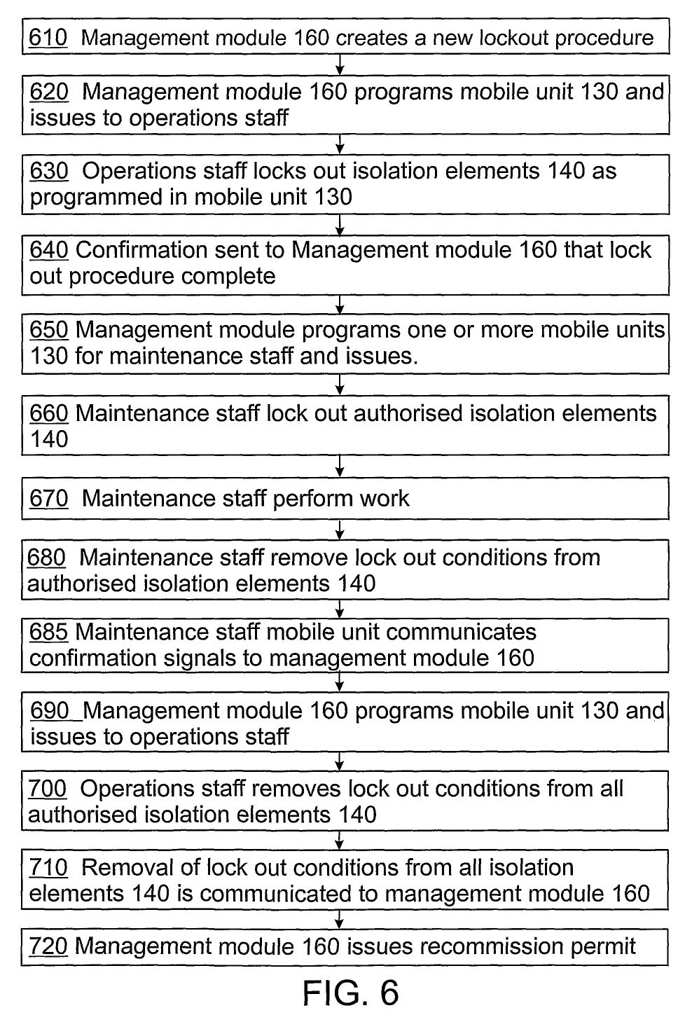

FIG. 6 shows a lock out method according to a further embodiment of the present invention wherein management module 160 administers the lockout procedure. In this embodiment of the present invention provides for an operations staff member that is responsible for ensuring that all isolation elements 140 on a piece of equipment are isolated prior to maintenance staff being able to perform work on the equipment.

Management module 160 first creates a new lockout procedure (step 610) whereby all isolation elements 140 that must be isolated for a particular task are identified and a mobile unit 130 is programmed with the unique isolation identifier's of the isolation element identification devices which are to be locked out. This mobile unit 130 is then issued to an operation staff member (step 620). Additionally, a number of electro-mechanical locking devices 110 are also issued to the operations staff member in order that they may physically lock out each isolation module 140.

Preferably, the mobile unit 130 issued to the operations staff member is only programmed by the management module 160 to lock the isolation elements 140 that form part of the set of isolation elements 140 to be locked.

The operation staff member then locks out the set of isolation elements 140 having the unique identification codes of the element identification device 120 stored in the mobile unit 130 by the management module 160 (step 630). The process of locking out an isolation element 140 has been described in detail above.

Optionally, the operations staff may only be authorized to lock the isolation elements 140 in an order determined by the management module 160 and this predetermine order is programmed in to mobile unit 130.

Once the locking procedure has been completed by the operations staff, the mobile communication device is placed in communication with management module 160. As previously discussed, this involves either placing the mobile communication device in communication with a communication module 150 or may be in direct communication with management module 160 via a wireless communication network. The mobile unit 130 then communicates with management module 160 confirming that all isolation elements 140 have been locked (step 640). As discussed above, this involves communicating the confirmation messages received from the electro-mechanical locking devices and/or the isolation identification devices indicating that the isolation element has been successfully locked.

Management module 160 then programs one or more mobile communication devices 130 with authorizations to lock and unlock the isolation elements 140 in the set of isolation elements 140 for the current job (step 650). The maintenance staff then lock out desired isolation elements 140 for which they have been authorized (step 660) as described previously and perform the necessary work (step 670).

Preferably, each maintenance staff member has a single electromechanical locking device 110 that they may physically lock each isolation element 140 for which they have been authorized to do so by management module 160. Hence, the maintenance staff may move their electromechanical locking device 130 and lock and unlock this electro-mechanical locking device 130 to each allowable isolation element 140.

Hence, each electro-mechanical locking device 110 is mated to a mobile unit 130 by the management module 160 at issuance and the mobile unit 130 is only able to lock or unlock this electromechanical locking device 110 when it issues a lock command that contains the unique operator identification code of the mobile unit 130 and the unique isolation identifier code of the isolation element 140. The maintenance staff member is then able to freely lock and unlock their electro-mechanical locking device 110 to all isolation elements 140 within the set of isolation elements 140 of the current job.

Optionally, a single electro-mechanical locking device 110 is present at each isolation element and each mobile unit 130 “locks” the electro-mechanical locking device 110 by adding the unique operator identification code stored within the mobile unit 130 with this identifier being added to the electro-mechanical locking devices processing and storage module 112 as previously described.

Optionally, as each isolation element 140 is locked by a maintenance staff member, a confirmation signal is communicated to management module 160 in order that management module 160 has a real time data store of the activities of all maintenance staff members. This information may be communicated from mobile unit 130 to management module 160 directly via a wireless communication network. Alternatively, this information may be communicated from mobile unit 130 to management module 160 by placing mobile unit 130 in communication with a communication module 150.

Upon completion of the job, the maintenance staff members then unlock each of the isolation elements 140 that they have locked (step 680). As previously discussed, this may involve removing their unique operator identifier, using their issued mobile unit 130, for an electro-mechanical locking device 130 dedicated to each isolation element 140. Alternatively, this may involve removing the maintenance staff members electro-mechanical locking device 110 from isolation element 140 using the staff members mobile unit 130 which has been mated thereto.

When all isolation elements have been unlocked by the maintenance staff members, and confirmation messages have been communicated to management module (step 685), indicating that no more maintenance staff are working in the isolation area, the management module programs a mobile unit 130 with unlock authorizations for each of the isolation elements in the current job and issues this mobile unit 130 to the operations staff member (step 690).

The operations staff member then removes the lock out conditions from the isolation elements as authorized and programmed by the management module 160 into the mobile unit 130 (step 700). This unlocking process has been discussed in detail above. Optionally, the operations staff member may only unlock the isolation elements 140 in the set of isolation elements 140 in an order determined by the management module and programmed into mobile unit 130 by the management module.

When all of the isolation elements 140 have been unlocked, the operation staff member then puts the mobile unit 130 into communication with the management module 160 (step 710). Preferably, the mobile unit 130 is placed in communication with a communication module 150 and data is transferred from the mobile unit 130 to the management module 160. Alternatively, the mobile unit 130 may communicate directly with the management module 160 via a wireless telecommunications network.

Preferably, the mobile unit 130 communicates the confirmation messages received from the isolation elements 140 indicating the relevant isolation element 140 has been unlocked and these confirmation messages are communicated to the management module 160.

The management module 160 then issues a re commission permit indicating that the maintenance job has been completed and the item(s) of plant equipment may be safely re-energized for use (step 720).

Throughout the specification the aim has been to describe the invention without limiting the invention to any one embodiment or specific collection of features. Persons skilled in the relevant art may realize variations from the specific embodiments that will nonetheless fall within the scope of the invention.

For example, a mobile unit 130 may be pre-programmed to lockout a series of isolation elements 140 in a particular sequence. This may be facilitated by the mobile unit 130 having a sequence of unique isolation identifier's stored in the processing and data storage module 112. Hence, an alarm will be sound if the operator does not lockout the isolation elements 140 in the sequence stored in the processing and data storage module 112.

In a further embodiment, the electromechanical lock 110 and the mobile unit 130 are issued with an operator at the commencement of a working shift. At this time, the mobile unit 130 has the operators unique identifier stored in the processing and data storage module 132. Additionally, the processing and data storage module 112 of the electro-mechanical locking device 110 is configured such that it can only be locked by the mobile unit 130 issued to the operator. Preferably, this is facilitated by the operators unique identifier being stored in the processing and data storage module 112 of the electro-mechanical locking device 110.

As such, the electromechanical locking device 110 can only be locked/unlocked by a single mobile unit 130 with which it has been mated. Hence, when any locking/unlocking request is communicated to the electro-mechanical locking device 110 from a mobile unit 130, it compares the unique identifier received from this mobile unit 130 with that stored in the processing and data storage module 112. If these identifiers correspond the request is executed and the locking device locks/unlocks. If the identifiers do not correspond then the electro-mechanical locking device 110 refuses the request.

Upon completion of the operator's shift, the electro-mechanical locking device 110 and the mobile unit 130 are returned to a shift supervisor so that they may have the operator's unique identifier erased in order that another operator may use these items.

Furthermore, management module 160 stores all information communicated thereto in order that an auditable record of all lock out procedures is retained for future reference. Suitably, management module 160 is compatible with prior art permit to work data systems in order that the method and system of the present invention may be seamlessly integrated with these legacy systems.

It will be appreciated that various other changes and modifications may be made to the embodiment described without departing from the spirit and scope of the invention.

1. A lockout method for locking out at least one isolation element of a plant, said method including the steps of:
(i) communicating a locking signal from a mobile unit to an electro-mechanical locking device whilst said electro-mechanical locking device is in an unlocked position, said locking signal including a unique operator identifier whereby said electromechanical locking device is moved to a locked position in response to said locking signal;
(ii) storing said unique operator identifier in said electro-mechanical locking device; and
(iii) communicating a confirmation signal from said electro-mechanical locking device to said mobile unit, said confirmation signal confirming said electro-mechanical locking device is in said locked position;
wherein, said electro-mechanical locking device isolates energy at said isolation element when said electro-mechanical locking device is in said locked position.

2. The method of claim 1 wherein said method further includes the step of:
(iv) storing said confirmation signal in said mobile unit.

3. The method of claim 1 wherein said electro-mechanical locking device may only be returned to said unlocked position by communicating an unlocking signal to said electro-mechanical locking device, said unlocking signal including said unique operator identifier.

4. The method of claim 3 wherein said mobile unit communicates said unlocking signal to said electro-mechanical locking device.

5. The method of claim 1 wherein said electro-mechanical locking device is located separately to said isolation element.

6. The method of claim 1 wherein said electro-mechanical locking device forms part of said isolation element.

7. The method of claim 1 wherein said electro-mechanical locking device moves to said locked position in step (i) in response to a predetermined unique operator identifier being communicated in said locking signal.

8. The method of claim 1 wherein said electro-mechanical locking device moves to said locked position in step (i) in response to any unique operator identifier being communicated in said locking signal.

9. The method of claim 1 wherein said electro-mechanical locking device is able to receive locking signals from one or more further mobile units when said electro-mechanical locking device is in said locked position with said unique operator identifier included in said locking signal of each said one or more further mobile units being stored in said electro-mechanical locking device.

10. The method of claim 9 wherein said electro-mechanical locking device moves to said unlocked position when said electro-mechanical locking device has received unlock signals from all of said mobile units having a unique operator identifier that has previously been stored in said electro-mechanical locking device in response to said locking signals from said mobile units.

11. A lock out method for locking out at least one isolation element of a plant, said method including the steps of:
(i) communicating a unique isolation element identifier from an isolation element identification device to a mobile unit, said isolation element identification device identifying said isolation element;
(ii) storing said unique isolation element identifier in said mobile unit;
(iii) communicating a locking signal from a mobile unit to an electro-mechanical locking device whilst said electro-mechanical device is in an unlocked position, said locking signal including a unique operator identifier whereby said electro-mechanical locking device is moved to a locked position isolating energy at said isolation element in response to said locking signal;
(iv) storing said unique operator identifier in said electro-mechanical locking device;
(v) communicating a confirmation signal from said electro-mechanical locking device to said mobile unit, said confirmation signal confirming said electro-mechanical locking device is in said locked position;
(vi) storing said confirmation signal in said mobile unit;
(vii) detecting, at said isolation element identification device, that energy has been isolated at said isolation element; and, if so;
(viii) communicating a confirmation signal from said isolation element identification device to said mobile unit; and
(ix) storing said confirmation signal in said mobile unit.

12. The method of claim 11 wherein step (i) further includes the step of starting an isolation timer at said mobile unit.

13. The method of claim 12 wherein step (viii) further includes the step of stopping said isolation timer at said mobile unit.

14. The method of claim 12 wherein said mobile unit initiates an alarm if said isolation element identification device does not communicate said confirmation signal to said mobile unit in step (viii) within a period set by said isolation timer.

15. The method of claim 11 wherein said method further includes the step of:
(x) communicating said confirmation signal to a management module.

16. The method of claim 15 wherein said confirmation signal communicated to said management module includes said confirmation signal communicated from said electro-mechanical locking device to said mobile unit.

17. The method of claim 15 wherein said confirmation signal communicated to said management module includes said unique operator identifier.

18. The method of claim 15 wherein said confirmation signal communicated to said management module includes said unique isolation element identifier.

19. The method of claim 15 wherein said confirmation signal communicated to said management module is communicated from said isolation element identification device.

20. The method of claim 15 wherein said confirmation signal communicated to said management module is communicated from said mobile unit.

21. An electro-mechanical locking device for locking out at least one isolation point of a plant, said device comprising:
a processing and data storage module;
a data port in communication with said processing and data storage module; and
a lock moveable between a locked position and an unlocked position under control from said processing and data storage module and in response to a locking signal received at said data port;
whereby, said processing and data storage module communicates a confirmation signal to said data port data and processing module detects when said lock has been moved to said locked position.

22. The electro-mechanical locking device of claim 21 wherein said lock is moveable between said locked position and said unlocked position in response to a locking signal being received at said data port, said locking signal including a predetermined unique operator identifier.

23. The electro-mechanical locking device of claim 21 wherein said electro-mechanical locking device is moveable between an unlocked position and a locked position in response to an unlocking signal received at said data port.

24. The electro-mechanical locking device of claim 21 wherein said unlocking signal includes a predetermined unique operator identifier.

25. A mobile unit adapted for communication with an electro-mechanical locking device for locking out at least one isolation element of a plant, said mobile unit comprising:
a processing and data storage module, said processing and data storage module having a unique operator identifier stored therein; and
a data port in communication with said processing and data storage module;
wherein, said mobile unit is adapted to communicate a locking signal to said electro-mechanical locking device to move said electro-mechanical locking device to a locked position, said locking signal including said unique operator identifier, said mobile unit further adapted to receive a confirmation signal from said electro-mechanical locking device confirming said electro-mechanical locking device is in said locked position.

26. A lockout system for isolating at least one isolation element of a plant, said system comprising:
an electro-mechanical locking device moveable between an unlocked position and a locked position, said locked position isolating energy at said isolation element; and
a mobile unit adapted to communicate with said electro-mechanical locking device to move said locking device between said locked position and said unlocked position;
wherein, said electro-mechanical locking device moves to said locked position in response to a locking signal being communicated from said mobile unit to said electro-mechanical locking device, said electro-mechanical locking device communicating a confirmation signal to said mobile unit confirming said electro-mechanical locking device is in said locked position.

27. The system of claim 26 wherein said system further comprises a management module in communication with said mobile unit in order that said mobile unit is able to communicate said confirmation signal to said management module.
